(19) United States
(12) Patent Application Publication
(10) Pub. No.: US 2005/0021718 A1
(43) Pub. Date: Jan. 27, 2005

(54) Centrally managed differentiated service

(75) Inventor: Dwayne J. Sinclair, Dallas, TX (US)

Correspondence Address: CARR LAW FIRM, L.L.P., 670 FOUNDERS SQUARE, 900 JACKSON STREET, DALLAS, TX, 75202, US

(73) Assignee: Palliser Networks, Inc., Dallas, TX (US)

(21) Appl. No.: 10/842,324

(22) Filed: May 10, 2004

Related U.S. Application Data
(60) Provisional application No. 60/469,330, filed on May 9, 2003.

(51) Int. Cl. G06F 15/173

(52) U.S. Cl. 709/223

(57) ABSTRACT

The present invention provides for Internet Protocol connected computing device. A server is configured to transmit a QOS parameter. At least one Internet Protocol computing device is configured to receive the QOS parameter. QOS parameters can be transmitted and set at the computing device, thereby avoiding setting QOS parameters at the routers and switches. Instead, the computing devices set QOS policy defined from a centralized server.

### CLAIM OF PRIORITY

This Application claims priority from “Centrally Managed Differentiated Services” filed May 9, 2003, Ser. No. 60/469,330, and is hereby incorporated by reference in its entirety.

### FIELD OF THE INVENTION

The present invention is generally directed to networks and, more particularly, to the centralized management of Internet Protocol network Layer 2 and Layer 3 Quality of Service (QOS) and/or Differentiated Service values

### BACKGROUND

QOS can be used to control network traffic. In conventional technologies, QOS can be controlled through the use of various operating systems (OS), such as UNIX, Windows XP, Windows NT, and so forth. However, each OS has its own individual set of parameters that can set QOS, and the QOS options for one OS can be different for another OS.

Therefore, hardware implementation of QOS standards is used at certain devices.

Differentiated services can be generally defined as referring to a mixture of various traffic types of Internet Protocol traffic, such as interactive traffic versus batch traffic, voice, video, and so on. Differentiated Services Code Point (DSCP) is a standard for defining QOS in Layer 3 Internet Protocol (IP) datagrams. DSCP remaps older QOS parameters in the Layer 3 IP header and is structured as to be backward compatible. DSCP QOS values provide the flexibility to mix multimedia voice and video application data with traditional batch file transfer, and interactive data. Given that Internet Protocol networks support limited Layer 2 QOS, this current invention will apply Layer 3 DSCP QOS. Existing technologies attempt QOS, such as mandating a maximum packet drop rate, through the use of technologies that perform manipulation of Layer 2 and Layer 3 Quality of Service and/or Differentiated Service values on Internet Protocol networking switches and routers. In conventional technologies, network enterprises consider the Internet Protocol network computing devices, the “end nodes,” as “untrusted,” and use a router or a switch to set QOS standards. Both implementation of the QOS standards, and the setting of the policy itself, is performed on the router/switch devices.

However, there are some problems with this approach of treating the end nodes as “untrusted.” Although the manipulation of the data occurs at the Layer 2 and Layer 3 of the switch and/or router port, it is difficult to correlate the Layer 1 physical port of the switch and/or router and its specific QOS configuration to the actual device or devices which connect to the port. Worst case is a router with a single port that may connect to hundreds of end nodes that each has unique QOS requirements. This complex implementation of QOS at the switch and/or router occurs because the end nodes are treated as not trusted, which in turns means extra hardware on the router or switch to compensate. Furthermore, each router or switch can have its own set of individual QOS policies, capabilities and implementation mechanisms implement QOS, as well as the additional requirement of complex router configuration to police the data flows. Therefore, it becomes increasingly difficult to implement standard enterprise-wide QOS solutions.

Therefore, there is a need for a centralized management of QOS for Internet Protocol layers 2 and 3 that addresses at least some of the issues associated with conventional manipulation of Layer 2 and Layer 3 QOS parameters by switches and/or routers.

### SUMMARY OF THE INVENTION

The present invention provides for Internet Protocol connected computing device. A server configured to transmit a QOS parameter. At least one Internet Protocol computing device is configured to receive the QOS parameter.

### BRIEF DESCRIPTION OF THE DRAWINGS

For a more complete understanding of the present invention, and the advantages thereof, reference is now made to the following description taken in conjunction with the accompanying drawings, in which:

FIG. 1 is a system diagram showing the interaction between the flows of Internet Protocol network datagrams;

FIG. 2 is a block diagram showing the standard network protocol stack and the general location of Layer 2 Quality of Service values and Layer 3 Quality of Service/DSCP parameters that will be manipulated;

FIG. 3 is a block diagram showing the possible information that will be contained in the profile & control file;

FIG. 4 is an example of different profiles/control files that could be sent to specific Internet Protocol network computing devices to manipulate Layer 2 QOS and Layer 3 QOS/DSCP;

FIG. 5 is a system diagram showing the relationship between the specific Layer 2 QOS and Layer 3 QOS/DSCP profile database server of the present invention and other Internet Protocol computing devices connected by a Layer 2 and/or layer 3 Internet protocol network showing the distribution of profiles from the database server to specific Internet Protocol computing devices; and

FIG. 6 illustrates the effect on Internet Protocol datagrams caused by the application of specific Layer 2 QOS parameters and Layer 3 QOS/DSCP parameters as detailed in the profile received from the database server.

### DETAILED DESCRIPTION

In the following discussion, numerous specific details are set forth to provide a thorough understanding of the present invention. However, it will be understood by those skilled in the art that the present invention can be practiced by those skilled in the art following review of this description, without such specific details. In other instances, well-known elements have been illustrated in schematic or block diagram form in order not to obscure the present invention in unnecessary detail. Additionally, for the most part, details concerning CDMA systems and the like have been omitted inasmuch as such details are not considered necessary to obtain a complete understanding of the present invention, and are considered to be within the skills of persons of ordinary skill in the relevant art.

It is further noted that, unless indicated otherwise, all functions described herein are performed by a processor such as a computer or electronic data processor in accordance with code such as computer program code, software, and/or integrated circuits that are coded to perform such functions.

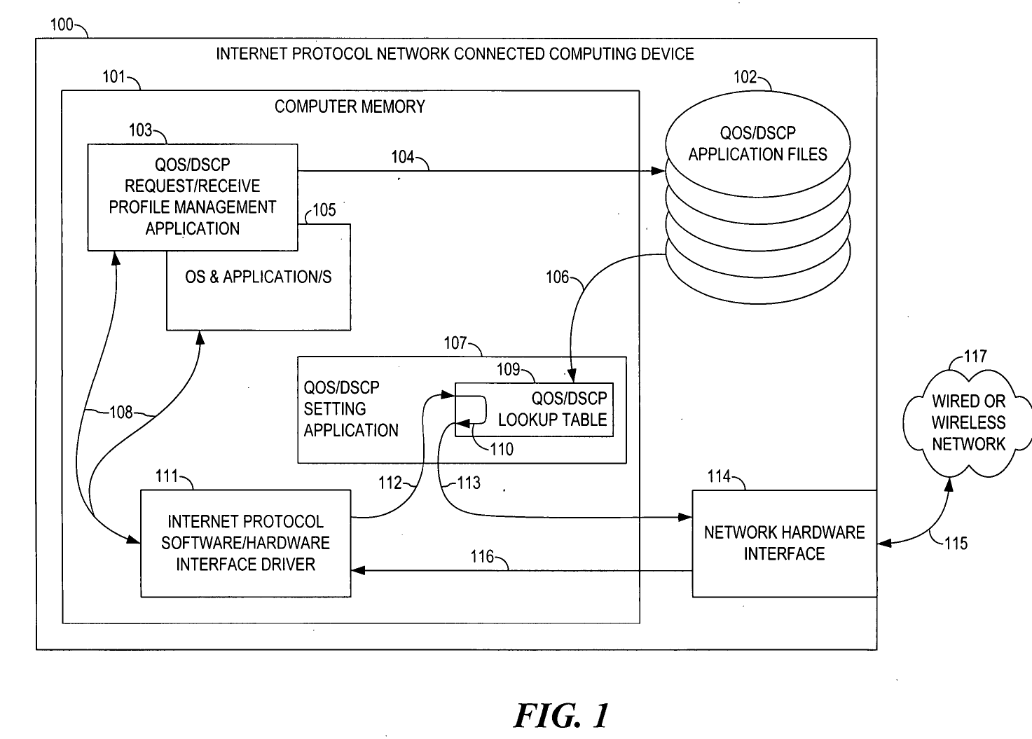

Referring to FIG. 1, illustrated is a system diagram showing the flow of Internet Protocol network datagrams. Generally, FIG. 1 defines Internet Protocol Layer 2 Quality of Service (QOS) parameters and Layer 3 Quality of Service and/or Distributed Service Codepoint (DSCP) parameters, and then stores these parameters in a database on a server accessible remotely by an Internet Protocol network computing device, such as through an industry standard web browser. Once Layer 2 and Layer 3 QOS/DSCP profiles are defined, FIG. 1 creates a system of distributing QOS/DSCP profiles from the database server to Internet Protocol computing devices where the profiles are used to dynamically change Layer 2 QOS parameters and Layer 3 QOS/DSCP parameters in Internet Protocol datagrams, which will be subsequently sent by the Internet Protocol computing devices. This allows an enterprise policy for Quality of Service to be centrally defined and managed and distributed. In one embodiment, the server is further configured to employ at least Kerberos, Radius, or Tacacs software

An Internet Protocol network computing device 100 is illustrated, such as a personal computer or server computer running an operating system capable of running applications 105 that use Internet Protocol to communicate over a computer network 117. A QOS/DSCP Request Receive Profile Management Application 103 receives a QOS/DSCP profile from a central server (not shown) and stores 104 the profile in a file 102 on the computing device 100. The profile is copied 106 to computer memory 109 on the computing device 101 to ensure that a QOS/DSCP Lookup Table 107 program can manipulate Internet Protocol datagrams 112 quickly and efficiently. As Internet Protocol datagrams are generated by an operating system 105 or applications 105 initially pass through the flow 108 to the Internet Protocol software/hardware interface driver 111, datagrams are directed 112 through the QOS/DSCP 107. The Internet Protocol datagrams are verified against the QOS/DSCP profile 109, possibly modified 110 and forwarded on 113 to the network hardware interface 114 for transmission 115 onto the wired or wireless Internet Protocol network 117. In the computing device 100, Internet Protocol datagrams received 108 from the Internet Protocol network software/hardware drive 113 are forwarded directly to the operating system and applications 105 or QOS/DSCP Request/Receive Profile Management Application 103 as there is no ability or requirement to mark received datagrams.

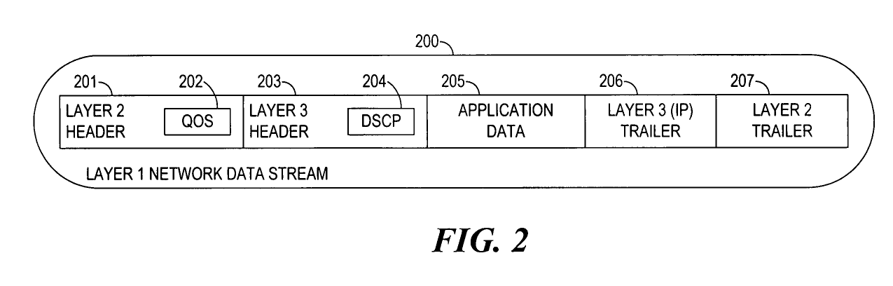

Referring to FIG. 2, a block diagram showing network protocol stack and the general location of Layer 2 Quality of Service values and Layer 3 Quality of Service/DSCP are illustrated. These parameters are manipulated by 107 and 109 of FIG. 1, as opposed to within a router or switch. A data frame as transmitted over a wires or wireless computer network is illustrated as using a Layered model, wherein Layer 1 200 is data on a wired or wireless network, Layer 2 201 & 207 encapsulates Layer 3 203 & 206, which in turn encapsulates application data 205. Layer 2 Quality of Service parameters 202 are applicable only on the directly connected wired or wireless the Internet Protocol network computing device (not shown) to which the computer device 100 is connected. Layer 2 Quality of Service parameters 202 allow Layer 2 network concentrators (for example hubs, switches) to prioritize network traffic on the local network. Layer 3 Quality of Service and/or Differentiated Service Codepoints are applicable across the end to end enterprise network and allow Internet Protocol network routers to prioritize traffic across the enterprise network. The management software, installed on a server distributes QOS policies to the various end nodes to allow end nodes to set QOS values, as opposed to the routers and switches.

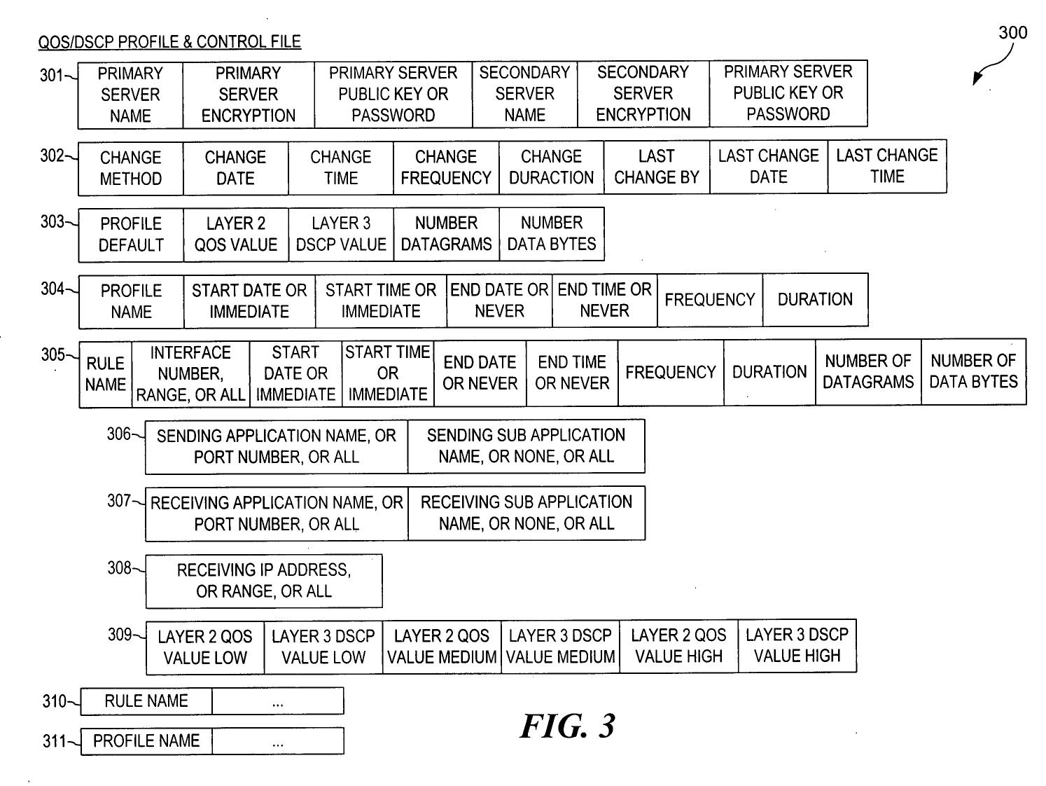

Referring to FIG. 3, a block diagram showing the information can be contained in the profile & control file 300 that would be distributed to, received and stored on end nodes 103, 102, 109 of FIG. 1 to define the rules by which QOS would be modified. A profile/control file 300 contains a control record 301 with primary and secondary server Internet Protocol name 301 in Internet Protocol address or domain name service name format, as well as encryption/password information 301 to allow the Internet Protocol computing device (not shown) the ability to confirm through password and/or encryption the received profile is from a valid source. A change method control record 302 will include the method of change 302 (a push from the server or a pull from the server), the date, time, frequency, and duration of change 302, and well as specific information on the last change by, date, and time 302. A profile default record 303 specifies the default layer 2 Quality of Service values and Layer 3 Quality of Service and/or Differentiated Services Control Point values 303 (L2 QOS/L3 QOS/DSCP) allow the definition of L2 QOS/L3 QOS/DSCP values to be applied by the present invention for all Internet datagrams that do not match more explicit rules. Multiple profile name control records 304, 311 define a name for a profile with date, time, and duration parameters to control when to start and stop the application of specific L2 QOS/L3 QOS/DSCP rules.

Under each profile name control records 304, 311 specific rules are defined for controlling the application of L2 QOS/L3 QOS/DSCP values. Specifically sending application name, port number or all 306, and where supported, a sending sub application name 306 to allow applications running under other applications to be uniquely identified. Receiving application name or port number or all 307 allows L2 QOS/L3 QOS/DSCP to be applied to Internet Protocol datagrams based on the destination. Where supported, a receiving sub application name can be defined as receiving Internet Protocol address or range 307 or addresses or all control the application of L2 QOS/L3 QOS/DSCP values to a range of Internet Protocol addresses. The specific L2 QOS/L3 QOS/DSCP are now defined 309 and specify a range of values categorized as low, medium, and high. In one embodiment, if an application wants to change the priority of data based on transaction data, this can be performed dynamically through the use of a “cookie” in the datastream the manipulated 109 of FIG. 1 will recognize.

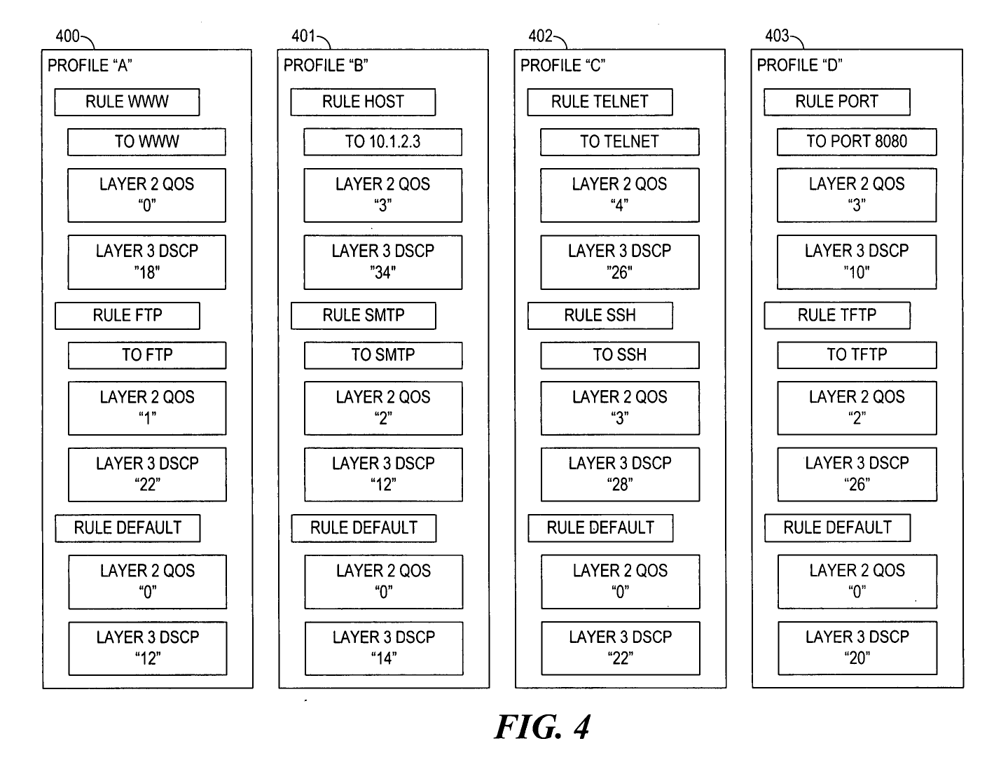

Referring to FIG. 4, illustrated is an example of different profiles that could be sent to specific Internet Protocol network computing devices to manipulate Layer 2 Quality of Service (L2QOS) and Layer 3 Quality of Service/Differentiated Service Codepoint (L3 QOS/DSCP) by QOS Setting Application 107 and 109 of FIG. 1. If, for example, L2QOS was using Ethernet 802.11p and L3QOS/DSCP was using Differentiated Service Codepoint, Profile “A” 400 shows that the Rule Default would set L2QOS to a value of “0” L3QOS/DSCP to a value of “12” for all traffic that did not match any other rule. Specific rules in Profile “A” 400 include a rule for traffic destined to web servers (WWW) which would set L2QOS to a value of “0” L3QOS/DSCP to a value of “18”, and a rule for traffic destined to file transfer servers (FTP) which would set L2QOS to a value of 1 L3QOS/DSCP to a value of “22”. Profile “B” 401 shows that the Rule Default would set L2QOS to a value of 0 L3QOS/DSCP to a value of “14” for all traffic that did not match any other rule. Specific rules in Profile “B” 401 include a rule for traffic destined to a specific Internet Protocol address 10.1.2.3 which would set L2QOS to a value of “3” L3QOS/DSCP to a value of “34”, and a rule for traffic destined to mail servers (SMTP) which would set L2QOS to a value of “2” L3QOS/DSCP to a value of “12”. Profile “C” 402 shows that the Rule Default would set L2QOS to a value of “0” L3QOS/DSCP to a value of “22” for all traffic that did not match any other rule.

Specific rules in Profile “C” 402 include a rule for traffic destined to telnet servers which would set L2QOS to a value of “4” L3QOS/DSCP to a value of “26”, and a rule for traffic destined to Secure Shell servers (SSH) which would set L2QOS to a value of “3” L3QOS/DSCP to a value of “28”. Profile “D” 403 shows that the Rule Default would set L2QOS to a value of “0” L3QOS/DSCP to a value of “20” for all traffic that did not match any other rule. Specific rules in Profile “D” 403 includes a rule for traffic destined to Internet Protocol application port 8080 which would set L2QOS to a value of “3” L3QOS/DSCP to a value of “10”, and a rule for traffic destined to Tint File Transfer Servers (TFTP) which would set L2QOS to a value of “2” L3QOS/DSCP to a value of “26”.

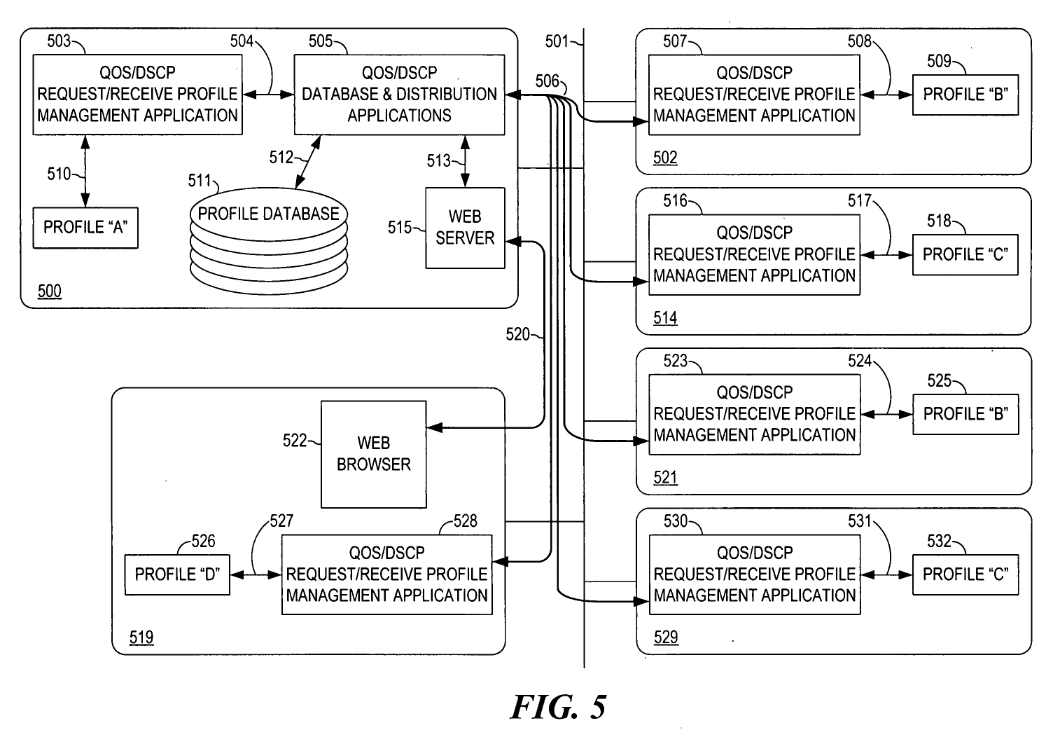

Referring to FIG. 5, a system diagram showing the relationship between the specific Layer 2 Quality of Service (L2QOS) and Layer 3 Quality of Service/Differentiated Service Codepoint (L3QOS/DSCP) profile database server 500 and other Internet Protocol computing devices 502, 514, 519, 521, 529 connected by a Layer 2 and/or Layer 3 Internet Protocol network 501 showing the distribution 506 of profiles 509, 510, 518, 525, 526, 532, from the profile database 511 on database server 500 of the a QOS/DSCP Database and Distribution Application 505 to specific Internet Protocol computing devices containing the QOS/DSCP Request Receive Management Applications 503, 507; 516, 523, 528, 530. A specific Internet Protocol computing device 519 with a web browser 522 is used to connect to the L2QOS and L3QOS/DSCP database web server 513 to create, change, and deploy L2QOS and L3 QOS/DSCP profiles stored in the profile database 511.

In FIG. 5, the L2QOS and L3QOS/DSCP server 500 also has the QOS/DSCP Request/Receive program 503 of the present invention to allow the L2QOS and L3QOS/DSCP to be set on Internet Protocol traffic outbound from this server. As shown, all Internet Protocol computing devices 500, 502, 514, 519, 521, 529 in this Figure have L2QOS and L3QOS/DSCP profiles 509, 510, 518, 525, 526, 529 some of which are identical to each other 509, 525 and 518, 532. Identical profiles 509, 525 and 518, 532 on these Internet Protocol computing devices 502, 521 and 514, 529 ensures that Internet Protocol datagrams being sent from these servers will have consistent L2QOS and L3QOS/DSCP values applied.

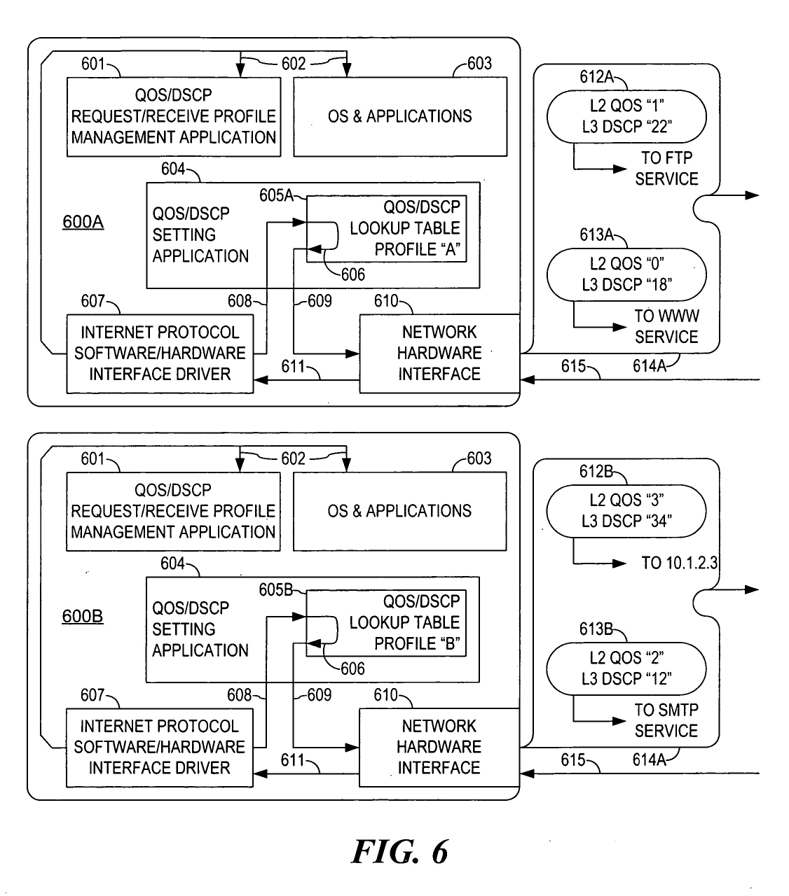

Turning now to FIG. 6, illustrated is an effect on Internet Protocol datagrams 612A, 613A, 612B, 613B from Internet Protocol computing devices 600A, 600B caused by the application of specific Layer 2 Quality of Service (L2QOS) parameters and Layer 3 Quality of Service/Distributed Service Codepoint (L3QOS/DSCP) parameters 606 by the present invention 604 as detailed in the profile 605A, 605B received from the database server of the present invention (not shown). Based on the application 606 of Profile “A” 605A in the Internet Protocol computing device 600A, Internet Protocol datagrams 612A, 613A sent to specific destination and/or applications have specific L2QOS and L3QOS/DSCP values applied on outbound datagrams 612A, 613A. Inbound datagrams 615 are not touched. Based on the application 606 of Profile “B” 605B in the Internet Protocol computing device 600B, Internet Protocol datagrams 612B, 613B sent to specific destination and/or applications have specific L2QOS and L3QOS/DSCP values applied on outbound datagrams 612B, 613B.

Inbound datagrams 615 are not touched. It is understood that the present invention can take many forms and embodiments.

Accordingly, several variations can be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention can be employed without a corresponding use of the other features. Many such variations and modifications can be considered obvious and desirable by those skilled in the art based upon a review of the foregoing description of preferred embodiments. Accordingly, it is appropriate that the appended claims be construed broadly and in a manner consistent with the scope of the invention.

1. An Internet Protocol Quality of Service definition system, comprising:
a server configured to transmit at least one QOS parameter; and
at least one Internet Protocol computing device configured to receive and set the QOS parameter.

2. The server of claim 1, further comprising a database for storing at least one Internet Protocol Layer 2 QOS object.

3. The server of claim 1, further comprising a database for storing at least one Internet Protocol layer 3 QOS object.

4. The server of claim 1, wherein the server is further configured to be a world wide web server.

5. The system of claim 1, wherein the at least one Internet Protocol computing device is configured to solicit, from the server, at least one Layer 2 Quality of Service object and/or at least one Internet Protocol Layer 3 Quality of Service.

6. The system of claim 1, wherein the at least one Internet Protocol computing device is further configured to solicit from the server Layer 2 Differentiated Service objects and/or Internet Protocol Layer 3 Differentiated Service objects.

7. The system of claim 1, wherein the Internet Protocol network computing devices is configured to correlate and apply Internet Protocol Layer 2 Quality of Service values to outbound Internet Protocol packets by correlating outbound Internet Protocol packets to the Internet Protocol Layer 2 Quality of Service objects.

8. The system of claim 1, wherein the Internet Protocol network computing devices is configured to correlate and apply Internet Protocol Layer 2 Quality of Service values to outbound Internet Protocol packets by correlating outbound Internet Protocol packets to said Internet Protocol Layer 3 Quality of Service objects.

9. The system of claim 1, wherein the Internet Protocol network computing devices is configured to correlate and apply at least one Internet Protocol Layer 2 QOS value to at least one outbound Internet Protocol packet through correlating at least one outbound Internet Protocol packet to an Internet Protocol Layer 3 Differentiated Service Codepoint object.

10. The system of claim 1, wherein the Internet Protocol network computing device identification has objects in either a computer memory or files or stored in a Database.

11. The system of claim 10, wherein in the Database, there is a description of an individual Internet Protocol network computing device, including MAC address, Internet Protocol address, date of last push/pull of said Internet Protocol Layer 2 Quality of Service object and/or date of last push/pull of said Internet Protocol Layer 3 Quality of Service/Differentiated Service Codepoint object.

12. The system of claim 1, wherein the server is further configured to employ at least Kerberos, Radius, or Tacacs software.

13. The system of claim 1, wherein the QOS/DSCP Request/Receive Profile Management Application is configured to provide logging and reporting of scheduled and unscheduled changes of QOS parameters.

14. The system of claim 14, wherein the server is configured to process statistics gathered from configured Internet Protocol network computing devices.

15 The system of claim 1 wherein, a connector is configured to provide encryption of data between said World Wide Web Application Server and said Web Browser on Internet Protocol network computing device.

16 The system of claim 1, wherein the QOS protocol is employed with association with the Internet Protocol version 4.

17. A method of distributing QOC information, comprising:
generating a QOS profile;
transmitting the QOS profile to a physical layer in communication within an Internet Protocol computing device;
receiving the QOS profile at an Internet Protocol computing device having the physical layer.

18. The method of claim 17, further comprising employing the QOS profile at the Internet Protocol connected computing device.

19. The method of claim 17, further comprising broadcasting the QOS profile from the server to a plurality of Internet Protocol connected computing devices.

20. The method of claim 17, further comprising requesting a transmission of the QOS profile from the server by the Internet Protocol connected computing device.

21. An Internet Protocol Quality of Service definition system, comprising:
a server configured to transmit at least one QOS parameter; and
at least one Internet Protocol computing device configured to receive and set the QOS parameter; and
at least one conveying device, wherein the conveying device is configured to enforce the at least one QOS parameter, but not to set the QOS parameter.

22. The server of claim 21, further comprising a database for storing at least one Internet Protocol Layer 2 QOS object.

23. The server of claim 21, further comprising a database for storing at least one Internet Protocol layer 3 QOS object.

24. The system of claim 21, wherein the conveying device comprises a router.

25. The system of claim 21, wherein the conveying device comprises a switch.
